(19) United States
(12) Patent Application Publication
(10) Pub. No.: US 2015/0070770 A1
(43) Pub. Date: Mar. 12, 2015

(54) OPTICAL ELEMENT, HEAD-UP DISPLAY AND LIGHT SOURCE UNIT

(71) Applicants: Takayuki Nomoto, Kanagawa (JP); Ikuya Kikuchi, Kanagawa (JP)

(72) Inventors: Takayuki Nomoto, Kanagawa (JP); Ikuya Kikuchi, Kanagawa (JP)

(73) Assignee: PIONEER CORPORATION, KANAGAWA (JP)

(21) Appl. No.: 14/391,706

(22) PCT Filed: Apr. 12, 2012
(86) PCT No.: PCT/JP2012/060035

§ 371 Date: Oct. 10, 2014

(51) Int. Cl. G02B 3/00; G02B 27/01

(52) U.S. Cl. CPC G02B 3/0043; G02B 3/0056; G02B 27/0101
USPC 359/626

(57) ABSTRACT

An optical element includes a microlens array on which plural microlenses are arranged. The microlens array includes plural areas whose microlenses have different curvature radii per area. The plural areas are configured so that the farther the area exists from the center of the microlens array, the smaller the curvature radius of the microlenses arranged on the area is.

### TECHNICAL FIELD

The present invention relates to a display technology using a microlens array.

### BACKGROUND TECHNIQUE

Conventionally, there is proposed a technique for applying a microlens array to a head-up display and a laser projector as an optical element for generating an intermediate image. When such an optical element for generating an intermediate image is applied, there is an advantage of suppressing the influence of a speckle noise compared to a case of a diffuser being applied.

For example, in Patent Reference-1, there is proposed an image forming device including a laser projector which uses a laser as a light source and which projects an image formed by an array of plural pixels, and a microlens array on which plural microlenses are arranged. When the microlens array is used, it is possible to appropriately disperse an incident light and freely design a necessary diffusing angle (i.e., angle of emergence). Meanwhile, in Patent Reference-2, there is proposed a technique of controlling the view angle in two axes perpendicular to each other on a plane that is normal to the light axis by individually adjusting the curvature radius and the aspherical coefficient corresponding to each of the two axes. Other related techniques are disclosed in Patent Reference-3 and Patent Reference-4.

### PRIOR ART REFERENCE

### Patent Reference

Patent Reference-1: Japanese Patent Application Laid-open under No. 2010-145745
Patent Reference-2: Japanese Patent Application Laid-open under No. 2007-517254
Patent Reference-3: Japanese Patent Application Laid-open under No. 2005-018057
Patent Reference-4: Japanese Patent Application Laid-open under No. 2010-014925

### DISCLOSURE OF INVENTION

### Problem to be Solved by the Invention

Generally, regarding a head-up display, designing a microlens array to have a large diffusing angle has an advantage of broadening the visible range (i.e., eye box) of the display image seen by an observer whereas it leads to such an disadvantage of decreasing the intensity of the light which enters the view point (i.e. eye point). Thus, the observer could feel too dark to visually recognize the display image. In contrast, designing a microlens array to have a small diffusing angle has an advantage of increasing the intensity of the light which reaches the eye point to raise the luminance whereas it leads to such a disadvantage that the eye box becomes small. This could cause such a disadvantage that the observer cannot visually recognize the whole display image due to a partial loss of the display image.

The present invention has been achieved in order to solve the above problem. It is an object of the present invention to provide an optical element, a head-up display and a light source unit capable of properly adjusting the luminance and letting the observer visually recognize the whole display image.

### Means for Solving the Problem

One invention is an optical element including a microlens array on which plural microlenses are arranged, wherein the microlens array includes plural areas whose microlenses arranged thereon have different curvature radii per area, and wherein the farther the area exists from a center of the microlens array, the smaller the curvature radius of the microlenses arranged on the area is.

Another invention is a light source unit including: an optical element configured to include a microlens array on which plural microlenses are arranged, and a light source configured to project light for displaying an image onto the optical element, wherein the microlens array includes plural areas whose microlenses arranged thereon have different curvature radii per area, and wherein the farther the area exists from a center of the microlens array, the smaller the curvature radius of the microlenses arranged on the area is.

### BRIEF DESCRIPTION OF THE DRAWINGS

FIG. 1 shows a schematic configuration of a head-up display.

FIG. 2 is a configuration diagram of a part of a light source unit.

FIG. 3 is a plane view of an optical element for generating an intermediate image according to an embodiment.

FIG. 4 illustrates microlenses onto which light is projected.

FIG. 5 schematically illustrates the diffusion of light entering the eye point from a combiner according to the embodiment.

FIGS. 6A and 6B schematically illustrate the diffusion of light which enters the eye point from a combiner according to comparative examples.

FIG. 7 is a plane view of an optical element for generating an intermediate image according to a first modification.

FIG. 8 is a plane view of an optical element for generating an intermediate image according to a second modification.

FIG. 9 is a plane view of an optical element for generating an intermediate image according to a third modification.

FIGS. 10A and 10B illustrate concrete configurations of a first microlens array and a second microlens array.

FIG. 11 is a perspective view of the optical element for generating an intermediate image according to a third modification.

### DETAILED DESCRIPTION OF THE PREFERRED EMBODIMENTS

According to a preferable embodiment of the present invention, there is provided an optical element including: a microlens array on which plural microlenses are arranged, wherein the microlens array includes plural areas whose microlenses arranged thereon have different curvature radii per area, and wherein the farther the area exists from a center of the microlens array, the smaller the curvature radius of the microlenses arranged on the area is.

An optical element includes a microlens array on which plural microlenses are arranged. The microlens array includes plural areas whose microlenses arranged thereon have different curvature radii per area. The plural areas are configured so that the farther the area exists from a center of the microlens array, the smaller the curvature radius of the microlenses arranged on the area is.

Generally, the light projected onto the position around the center of a microlens array constitutes pixels around the center of the display image seen by the observer whereas the light projected onto the outside of the microlens array constitutes outer pixels of the display image seen by the observer. It is also noted that the smaller the curvature radius of the microlenses arranged on an area is, the larger the diffusing angle of the light outputted from the area becomes. Above things considered, the optical element is configured so that the farther the area exists from the center of the microlens array, the smaller the curvature radius of the microlenses arranged on the area is. Thereby, in case of letting the observer see the display image through the optical element, it is possible to let the observer clearly see the inside part of the display image indicating relatively important information with an adequate luminance while letting the observer visually recognize the whole part of the display image.

In one mode of the optical element, the microlens array includes the plural areas that are an outside area corresponding to an outside part of the microlens array and an inside area surrounded by the outside area, and the curvature radius of the microlenses arranged on the outside area is smaller than the curvature radius of the microlenses arranged on the inside area. According to this mode, the optical element can let the observer clearly see the inside part of the display image indicating relatively important information with an adequate luminance while letting the observer visually recognize the whole part of the display image.

In another mode of the optical element, the microlens array includes the plural areas that are outside areas and an inside area, the outside areas being provided on both ends of the microlens array in a longitudinal direction of the microlens array, the inside area existing between the outside areas in the longitudinal direction, and the curvature radius of the microlenses arranged on the outside areas is smaller than the curvature radius of the microlenses arranged on the inside area. Generally, a display image part formed by the light passing through the both ends of the microlens array in the longitudinal direction tends to be lost from the view of the observer. Thus, in this mode, the optical element can let the observer clearly see the inside part of the display image indicating relatively important information with an adequate luminance while letting the observer visually recognize the whole part of the display image.

In still another mode of the optical element, the microlens array further includes at least one intermediate area existing between the outside area(s) and the inside area, and wherein the curvature radius of the microlenses arranged on the at least one intermediate area is smaller than the curvature radius of the microlenses arranged on the inside area and larger than the curvature radius of the microlenses arranged on the outside area(s). According to this mode, the optical element can raise the luminance in stages from the outside through the inside of the display image thereby to improve the visibility.

In still another mode of the optical element, the optical element includes a first and a second microlens arrays facing each other and each having plural microlenses arranged thereon, and at least one of the first and the second microlens arrays is configured as the microlens array. Even when the optical element is configured of two microlens arrays in this way, the optical element can let the observer clearly see the inside part of the display image indicating relatively important information with an adequate luminance while letting the observer visually recognize the whole part of the display image.

According to another preferable embodiment of the present invention, there is provided a head-up display which includes the above-mentioned optical element and makes a user perceive an image formed by the optical element as a virtual image at an eye position of the user. The head-up display with such an optical element can let the observer clearly see the inside part of the display image indicating relatively important information with an adequate luminance while letting the observer visually recognize the whole part of the display image.

According to still another preferable embodiment of the present invention, there is provided a light source unit including an optical element configured to include a microlens array on which plural microlenses are arranged, and a light source configured to project light for displaying an image onto the optical element, wherein the microlens array includes plural areas whose microlenses arranged thereon have different curvature radii per area, and wherein the farther the area exists from a center of the microlens array, the smaller the curvature radius of the microlenses arranged on the area is. According to this mode, the light source unit can let the observer clearly see the inside part of the display image indicating relatively important information with an adequate luminance while letting the observer visually recognize the whole part of the display image.

In one mode of the light source unit, the light source is a laser scanning light source. Due to the general nature of a laser scanning light source, when the optical element is irradiated by a laser scanning light source, the closer the scanning point is to either end of the optical element in the light scanning direction (i.e., main scanning direction), the slower the scan speed becomes. As a result, the closer the position is to either end of the display image in the horizontal direction, the higher the luminance tends to be. Thus, according to this mode, the light source unit can let the observer clearly see the inside part of the display image indicating relatively important information with an adequate luminance while letting the observer visually recognize the whole part of the display image.

### Embodiment

A preferred embodiment of the present invention will be explained hereinafter with reference to the drawings.

[Configuration of Head-Up Display]

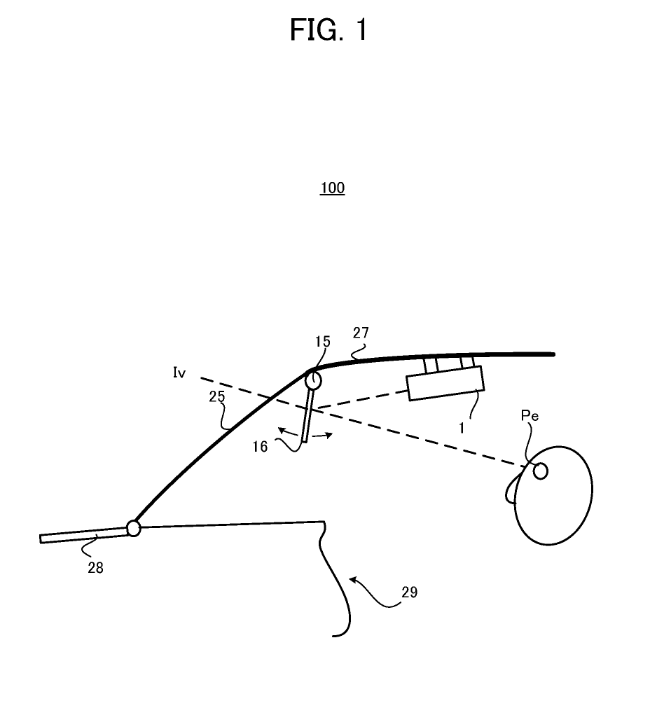

FIG. 1 illustrates the schematic configuration of a head-up display 100. As illustrated in FIG. 1, the head-up display 100 according to the embodiment includes a light source unit 1 and a combiner 16, and is installed in a vehicle having a front window 25, a ceiling board 27, a hood 28 and a dashboard 29.

The light source unit 1 is provided on the ceiling board 27 in the vehicle interior, and emits the light for displaying an image illustrating driver assist information towards the combiner 16. Examples of the driver assist information include a position of the vehicle, running speed of the vehicle, map information, and facility information. In particular, the light source unit 1 generates an intermediate image in the light source unit 1, and emits the light for displaying the image towards the combiner 16 thereby to let the driver visually recognize the virtual image “Iv” via the combiner 16.

The display image emitted from the light source unit 1 is projected onto the combiner 16, and the combiner 16 shows the display image as the virtual image Iv by reflecting the display image towards the eye point “Pe” of the driver. The combiner 16 has a support shaft 15 provided on the ceiling board 27 and rotates on the support shaft 15. For example, the support shaft 15 is provided on the ceiling board 27 near the top edge of the front window 25, i.e., near the position of a sun visor (not shown) for the driver.

[Configuration of Light Source Unit]

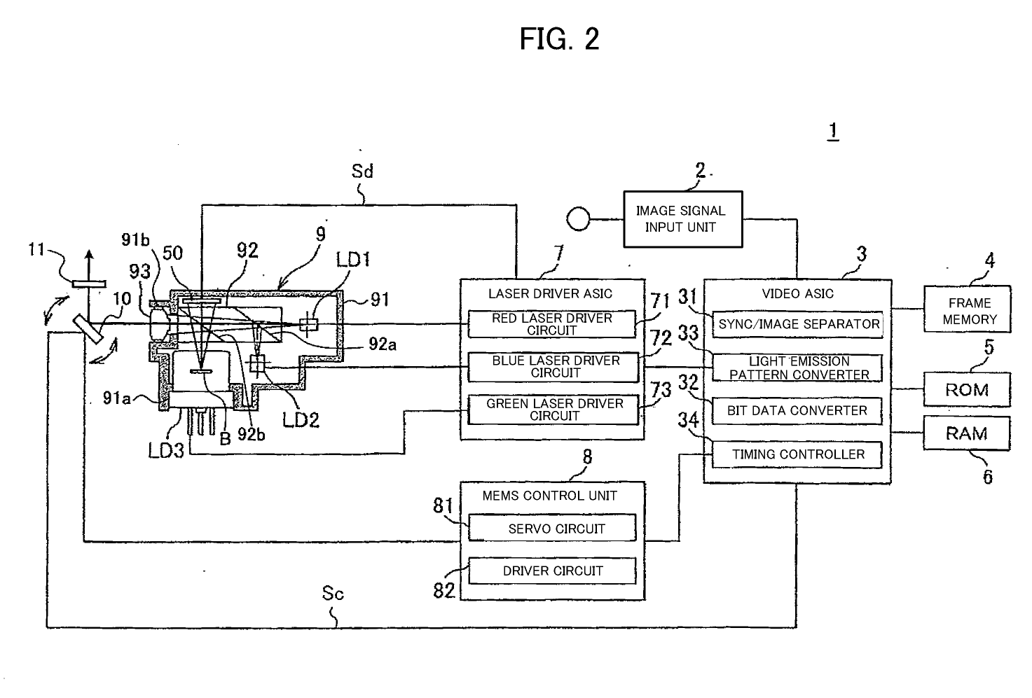

FIG. 2 is a configuration diagram of apart of the light source unit 1. As shown in FIG. 2, the light source unit 1 includes an image signal input unit 2, a video ASIC 3, a frame memory 4, a ROM 5, a RAM 6, a laser driver ASIC 7, a MEMS control unit 8, a laser light source unit 9, a MEMS mirror 10 and an optical element 11 for generating an intermediate image.

The image signal input unit 2 receives the image signal from the outside and outputs the image signal to the video ASIC 3.

The video ASIC 3 is formed as an ASIC (Application Specific Integrated Circuit) and controls the laser driver ASIC 7 and the MEMS control unit 8 based on the image signal inputted by the image signal input unit 2 and a scanning position information “Sc” inputted by the MEMS mirror 10. The video ASIC 3 includes a sync/image separator 31, a bit data converter 32, a light emission pattern converter 33 and a timing controller 34.

The sync/image separator 31 separates the image signal inputted by the image signal input unit 2 into a synchronous signal and image data displayed on a screen that is an image displaying unit, and writes the image data into the frame memory 4.

The bit data converter 32 reads out the image data written into the frame memory 4, and converts the image data into bit data.

The light emission pattern converter 33 converts the bit data converted by the bit data converter 32 into a signal indicating a light emission pattern of each laser.

The timing controller 34 controls an operation timing of the sync/image separator 31 and the bit data converter 32. Additionally, the timing controller 34 also controls an operation timing of the MEMS control unit 8 to be described later.

The image data separated by the sync/image separator 31 is written into the frame memory 4. The ROM 5 stores a control program and data for operating the video ASIC 3. The RAM 6 functions as a working memory of the video ASIC 3, and the video ASIC 3 sequentially reads and writes various data of the RAM 6.

The laser driver ASIC 7 is formed as an ASIC and generates a signal for driving laser diodes provided in the laser light source unit 9 to be described later. The laser driver ASIC 7 includes a red laser driver circuit 71, a blue laser driver circuit 72 and a green laser driver circuit 73.

The red laser driver circuit 71 drives a red laser LD1 based on the signal outputted by the light emission pattern converter 33. The blue laser driver circuit 72 drives a blue laser LD2 based on the signal outputted by the light emission pattern converter 33. The green laser driver circuit 73 drives a green laser LD3 based on the signal outputted by the light emission pattern converter 33.

The MEMS control unit 8 controls the MEMS mirror 10 based on the signal outputted by the timing controller 34. The MEMS control unit 8 includes a servo circuit 81 and a driver circuit 82.

The servo circuit 81 controls the operation of the MEMS mirror 10 based on the signal from the timing controller 34.

The driver circuit 82 amplifies the control signal of the MEMS mirror 10, which is outputted by the servo circuit 81, to a predetermined level, and outputs the amplified signal.

The laser light source unit 9 emits the laser light to the MEMS mirror 10 based on the drive signal outputted by the laser driver ASIC 7.

The MEMS mirror 10 serving as a scanning unit reflects the laser light emitted by the laser light source unit 9 to the optical element 11 for generating an intermediate image. Therefore, the MEMS mirror 10 forms the image to display on the optical element 11 for generating an intermediate image. Additionally, under the control of the MEMS control unit 8, the MEMS mirror 10 operates to perform scanning on the optical element 11 for generating an intermediate image in order to display the image inputted to the image signal input unit 2, and outputs the scanning position information (for example, an angle of the mirror 10) to the video ASIC 3.

The optical element 11 for generating an intermediate image is a transmission-type optical element for generating an intermediate image and is formed of a microlens array on which plural microlenses are arranged. The optical element 11 for generating an intermediate image moderately disperses the incident light. Concretely, the optical element 11 for generating an intermediate image diffuses the light by a diffusing angle in accordance with the curvature radius of the arranged microlenses. The curvature radius of the microlenses arranged on the optical element 11 for generating an intermediate image is preliminarily designed in accordance with a necessary diffusing angle. The detailed description of the optical element 11 for generating an intermediate image will be described in the section “Optical Element for Generating Intermediate Image”.

The light source unit 1 lets the combiner 16 reflect the light outputted from the above-mentioned optical element 11 for generating an intermediate image, and makes the driver perceive the image corresponding to the reflected light as the virtual image Iv at the eye point Pe of the driver.

Next, a description will be given of a concrete configuration of the laser light source unit 9. The laser light source unit 9 includes a case 91, a wavelength selective element 92, a collimator lens 93, a red laser LD1, a blue laser LD2, a green laser LD3 and a light receiving element 50 for monitoring (hereinafter simply referred to as “light receiving element”).

The case 91 is formed into a substantially box shape by a resin. The case 91 is provided with a CAN fixing part 91a and a collimator fixing part 91b. The CAN fixing part 91a has a hole through inside the case 91 for fixing the green laser LD3 and has a concave shaped cross-section. The collimator fixing part 91b is provided on a plane perpendicular to the CAN fixing part 91a, and has a hole through inside the case 91, and has a concave shaped cross-section.

The wavelength selective element 92 serving as a composite element is formed by a trichroic prism, for example, and is provided with a reflecting surface 92a and a reflecting surface 92b. The reflecting surface 92a transmits the laser light emitted by the red laser LD1 to the collimator lens 93, and reflects the laser light emitted by the blue laser LD2 to the collimator lens 93. The reflecting surface 92b transmits a large part of the laser light emitted by the red laser LD1 and the blue laser LD2 to the collimator lens 93, and reflects the other part of the light to the light receiving element 50. Additionally, the reflecting surface 92b transmits a large part of the laser light emitted by the green laser LD3 to the collimator lens 93, and reflects the other part of the light to the light receiving element 50. Thus, the lights emitted from the lasers are synthesized, and the synthesized light enters the collimator lens 93 and the light receiving element 50. The wavelength selective element 92 is provided near the collimator fixing part 91b in the case 91.

The collimator lens 93 converts the laser light from the wavelength selective element 92 into a parallel light, and emits the parallel light to the MEMS mirror 10. The collimator lens 93 is fixed on the collimator fixing part 91b in the case 91 by an ultraviolet adhesive. Namely, the collimator lens 93 is provided behind the composite element.

The red laser LD1 serving as the laser light source emits the red laser light. The red laser LD1 is fixed on the same axis as the wavelength selective element 92 and the collimator lens 93 in the case 91, in such a state that a semiconductor laser light source remains in a chip state or the chip is placed on a submount.

The blue laser LD2 serving as the laser light source emits the blue laser light. The blue laser LD2 is fixed at the position where the emitted light can be reflected to the collimator lens 93 by the reflecting surface 92a, in such a state that the semiconductor laser light source remains in the chip state or the chip is placed on the submount. The position of the blue laser LD2 may be replaced with the position of the red laser LD1.

The green laser LD3 serving as the laser light source is mounted on a CAN package or a frame package, and emits the green laser light. The green laser LD3 is provided with a semiconductor laser light source chip B in the CAN package which generates the green laser light, and is fixed on the CAN fixing part 91a in the case 91.

The light receiving element 50 receives a part of the laser light emitted by each laser light source. The light receiving element 50 is a photoelectric conversion element such as a photodetector, and supplies the laser driver ASIC 7 with a detecting signal Sd that is an electrical signal indicating the amount of the incident laser light. Specifically, the light receiving element 50 receives one of the red laser light, the blue laser light and the green laser light in a predetermined order at the time of adjusting the power, and outputs the detecting signal Sd indicating the amount of the laser light. On the basis of the detecting signal Sd, the laser driver ASIC 7 adjusts the power of the red laser LD1, the blue laser LD2 and the green laser LD3.

For example, when adjusting the power of the red laser LD1, the laser driver ASIC 7 operates only the red laser driver circuit 71 and makes the red laser LD1 emit the red laser light by supplying the driving current to the red laser LD1. The light receiving element 50 receives a part of the red laser light, and feeds the detecting signal Sd indicating the amount of the light back to the laser driver ASIC 7. The laser driver ASIC 7 adjusts the driving current supplied from the red laser driver circuit 71 to the red laser LD1 so that the amount of the light corresponding to the detecting signal Sd becomes an appropriate amount of the light. In this way, the power is adjusted. Each power of the blue laser LD2 and the green laser LD3 is adjusted in the same way.

[Optical Element for Generating Intermediate Image]

Next, a concrete description will be given of a configuration of the optical element 11 for generating an intermediate image according to the embodiment.

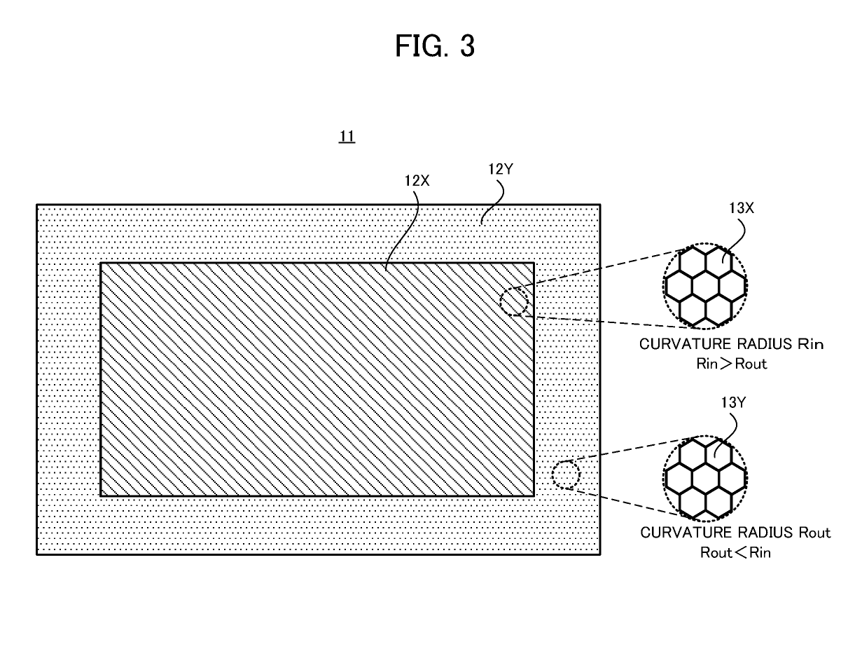

FIG. 3 is the plane view of the optical element 11 for generating an intermediate image according to the embodiment, wherein the optical element 11 for generating an intermediate image is observed from the light-entering direction. As illustrated in FIG. 3, the optical element 11 for generating an intermediate image has a lens-array inside area 12X formed as the inside of the optical element 11 for generating an intermediate image, and a lens-array outside area 12Y formed as the outside of the optical element 11 for generating an intermediate image. Though the optical element 11 for generating an intermediate image in FIG. 3 is formed into a substantially rectangle shape, it may be formed into any other shape such as a circular plate instead.

In the lens-array inside area 12X, a plurality of microlenses 13X, each of which is formed into a regular hexagon in the planar view, are arranged in a reticular pattern on one side of the optical element 11 for generating an intermediate image. In the lens-array outside area 12Y, a plurality of microlenses 13Y, each of which is formed into a regular hexagon in the planar view, are arranged in a reticular pattern on one side of the optical element 11 for generating an intermediate image in the same way. The microlenses 13X and the microlenses 13Y are arranged such that the center distance (referred to as “lens pitch”) of any two adjacent microlenses 13X is equal to the lens pitch of any two adjacent microlenses 13Y. Besides, each microlens 13X has the same thickness (size) and the same refractive index of the material as each microlens 13Y.

Here, the microlenses 13X and the microlenses 13Y are designed such that the curvature radius of each microlens 13X in the lens-array inside area 12X is different from the curvature radius of each microlens 13Y in the lens-array outside area 12Y. Specifically, the curvature radius “Rin” of each microlens 13X in the lens-array inside area 12X is larger than the curvature radius “Rout” of each microlens 13Y in the lens-array outside area 12Y as indicated by the following equation (1).

Rin>Rout (1)

By being designed so that the curvature radius Rin of each microlens 13X and the curvature radius Rout of each microlens 13Y meet the equation (1), the optical element 11 for generating an intermediate image can raise the luminance of the inside part of the display image seen by the observer while letting the observer visually recognize the whole display image including the outer edge thereof.

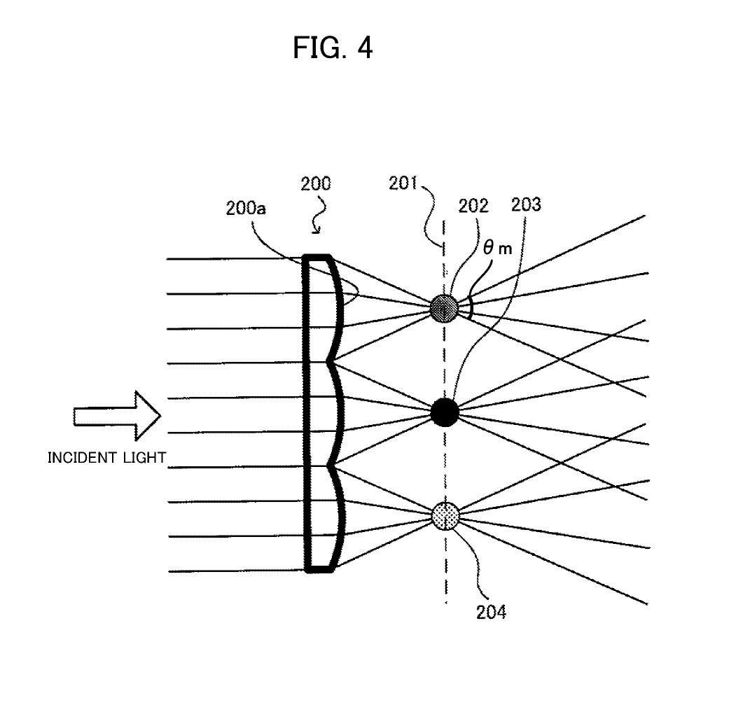

A description of the effect thereof will be given with reference to FIG. 4 to FIG. 6B.

FIG. 4 is a drawing for explaining an intermediate image generated by a normal microlens array 200. For example, provided that the microlens array 200 is applied to a laser scanning light source, the intermediate image whose each pixel position coincides with a focal point of each microlens 200a arranged in the microlens array 200 is formed on the plane (i.e., the focal plane, hereinafter referred to as “intermediate image plane”) indicated by the symbol 201. In case of FIG. 4, the intermediate image is configured of pixels 202, 203 and 204 each formed on the focal point of each microlens 200a. The intervals of the pixels 202, 203 and 204 are equal to the lens pitch of the microlens array 200.

Here, the diffusion angle (referred to as “diffusion angle θ”) at which the whole microlens array 200 diffuses the light is equal to the diffusion angle “θm” of each microlens 200a. Thus, the diffusion angle θ of the microlens array 200 has a relationship with the numerical aperture “NA” of each microlens 200a as indicated by the following equation (2).

NA=sin(θ/2) (2)

It is noted that the numerical aperture NA is adjustable by determining the curvature radius of microlenses 200a to an appropriate value. Thus, the diffusion angle θ is also adjustable by determining the curvature radius of the microlenses 200a to an appropriate value. Specifically, it is possible to decrease the diffusion angle θ by increasing the curvature radius of the microlens 200a and also possible to increase the diffusion angle θ by decreasing the curvature radius of the microlens 200a.

The diffusion angle θ is substantially the same index as the view angle that is a performance index of a liquid crystal display, and the smaller the diffusion angle θ is, the smaller the visible range (i.e., eye box) of the corresponding display image becomes. In contrast, the larger the diffusion angle θ is, the broader the diffusion range of the light becomes and the lower the light intensity to the eye point Pe becomes.

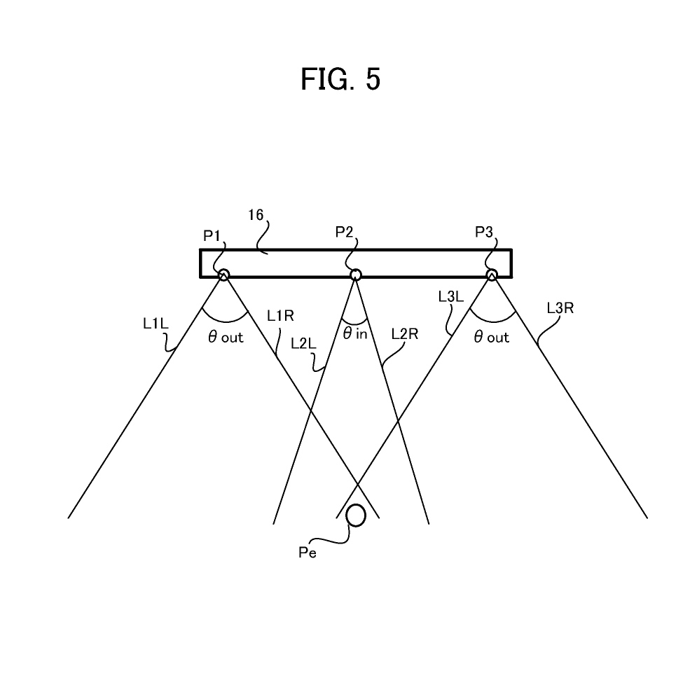

Incase of the optical element 11 for generating an intermediate image illustrated in FIG. 3, as indicated by the equation (1), the curvature radius Rin of the microlens 13X is larger than the curvature radius Rout of the microlens 13Y, and therefore the diffusing angle of the light which enters the lens-array inside area 12X is smaller than the diffusing angle of the light which enters the lens-array outside area 12Y. Besides, the light outputted from the optical element 11 for generating an intermediate image is reflected by the combiner 16 and the reflected light enters the eye point Pe. In this case, the diffusing angle of the light which passes through the lens-array outside area 12Y is larger than the diffusing angle of the light which passes through the lens-array inside area 12X. Thus, regarding the light reflected by the combiner 16, the diffusing angle of the reflected light which passes through the lens-array inside area 12X becomes small while the diffusing angle of the reflected light which passes through the lens-array outside area 12Y becomes large. The detailed description thereof will be given with reference to FIG. 5.

FIG. 5 schematically illustrates the diffusion of the light which enters the eye point Pe from the combiner 16 in a case that the combiner 16 and the eye point Pe are observed from the direction of the ceiling board 27. The position “P1” and the position “P3” in FIG. 5 are near the both ends of the combiner 16 in the longitudinal direction and correspond to the center position of the combiner 16 in the short direction. The position “P2” is near the center position of the combiner 16 in the longitudinal direction and corresponds to the center position of the combiner 16 in the short direction.

In case of FIG. 5, the light which passes through the lens-array outside area 12Y enters the positions P1 and P3, and the light which passes through the lens-array inside area 12X enters the position P2. In this case, the light for displaying the image corresponding to the position P1 near the left edge of the combiner 16 is diffused within the range between the light ray L1L and the light ray L1R which define the angle “θout”, and the light for displaying the image corresponding to the position P3 near the right edge of the combiner 16 is also diffused within the range between the light ray L3L and the light ray L3R which define the angle θout. In contrast, the light for displaying the image corresponding to the position P2 of the combiner 16 is diffused within the range between the light ray L2L and the light ray L2R which define the angle “θin”.

It is noted that the diffusing angle of the reflected light at the combiner 16 becomes large as the diffusing angle of the light which passes through the optical element 11 for generating an intermediate image is large. Accordingly, the angle θout is larger than the angle θin. Thereby, the light for displaying the image corresponding to the positions P1 and P3 near the both ends of the combiner 16 in the longitudinal direction enters the eye point Pe in addition to the light for displaying the image corresponding to the position P2 at the center part of the combiner 16 in the longitudinal direction. This enables the observer to properly recognize the display image corresponding to positions within the irradiated range of the combiner 16 including the positions P1 to P3, and therefore the observer can visually recognize the whole display image.

The light for displaying the image corresponding to the position P2 at or near the center of the combiner 16 enters the eye point Pe in such a state that an adequate light intensity is kept because the diffusing angle of the light corresponding to the position P2 is smaller than the diffusing angle of the light for displaying the image corresponding to the positions P1 and P3. Thus, the observer visually recognizes the display image corresponding to the position P2 in a state that an adequate luminance is kept.

In this way, according to the light source unit 1 equipped with the optical element 11 for generating an intermediate image illustrated in FIG. 3, the light for displaying the inside part of the image enters the eye point Pe with a proper light intensity while the light for displaying the outer part of the image enters the eye point Pe. Thus, the light source unit 1 can properly keep the luminance at the inside part of the display image which shows relatively important information while letting the observer visually recognize the whole display image.

In a case that the optical element 11 for generating an intermediate image is irradiated by a laser scanning light source, the closer the scanning point is to either end of the optical element 11 for generating an intermediate image in the light scanning direction (i.e., main scanning direction), the slower the scan speed becomes due to the nature of a laser scanning light source. As a result, the closer the position is to either end of the display image in the horizontal direction, the higher the luminance tends to be. Thus, the irradiation of the optical element 11 for generating an intermediate image by use of a laser scanning light source enables the observer to visually recognize even display image parts configured by the light which is reflected at the both ends (positions P1 and P3 in case of FIG. 5) of the combiner 16 in the longitudinal direction with an adequate luminance.

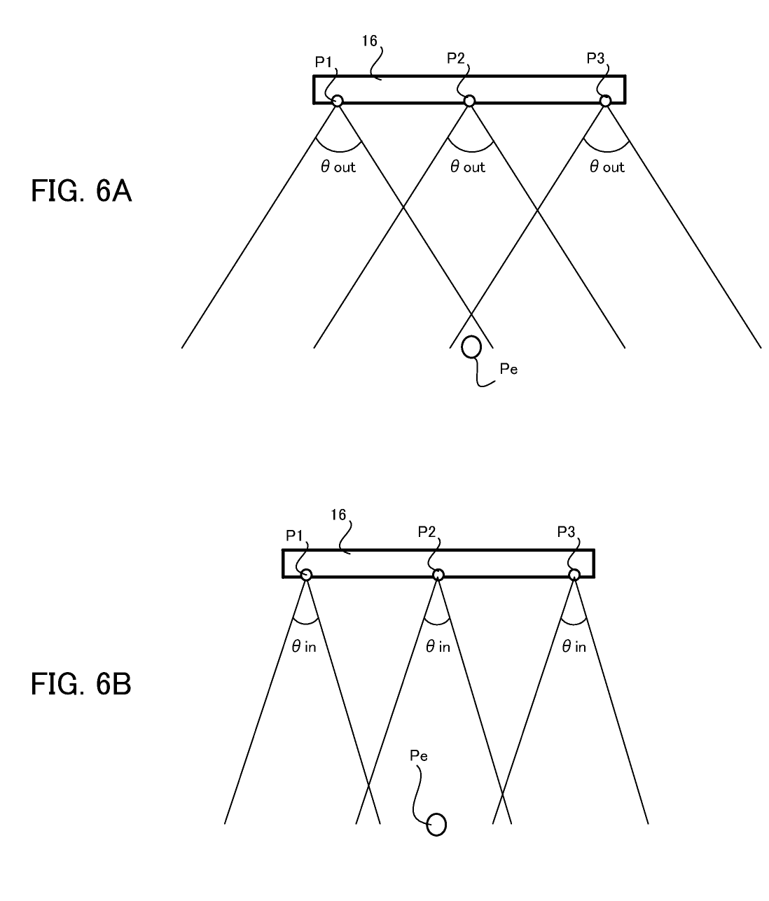

Next, with reference to FIGS. 6A and 6B, a description will be given of comparative examples in which microlenses with an equal curvature radius are arranged on the whole area of the optical element 11 for generating an intermediate image.

FIG. 6A illustrates the diffusion of the light which enters the eye point Pe from the combiner 16 in a case that microlenses 13Y with the curvature radius Rout are arranged on the whole area of the optical element 11 for generating an intermediate image.

In this case, the light for displaying the image corresponding to the position P2 that is near the center of the combiner 16 in the longitudinal direction diffuses at the angle θout as with the light reflected at the positions P1 and P3 near either end of the combiner 16. Thus, in this case, the intensity of the light outputted from the position P2 in FIG. 6A is smaller than the intensity of the light outputted at the position P2 in FIG. 5. In this way, in the case that the microlenses 13Y with a relatively small curvature radius are arranged on the whole area of the optical element 11 for generating an intermediate image, the luminance of an inside part of the display image becomes lower compared to the embodiment. As a result, according to the comparative example illustrated by FIG. 6A, it is impossible for the observer to clearly see the inside part of the display image indicating important information.

FIG. 6B schematically illustrates the light rays which enter the eye point Pe from the combiner 16 in a case that microlenses 13X with the curvature radius Rin are arranged on the whole area of the optical element 11 for generating an intermediate image.

In this case, the light for displaying the image corresponding to the positions P1 and P3 near either end of the combiner 16 in the longitudinal direction diffuses at the angle θin as with the light reflected at the position P2 near the center of the combiner 16. Thus, in this case, the diffusing angle of the light outputted from the positions P1 and P3 in FIG. 6B is smaller than the diffusing angle of the light outputted at the positions P1 and P3 in FIG. 5. As a result, as shown in FIG. 6B, each light for displaying the image corresponding to the positions P1 and P3 does not reach the eye point Pe. In this way, according to the comparative example illustrated in FIG. 6B, the observer cannot visually recognize the display image part corresponding to the outer irradiated area of the combiner 16 including the positions P1 and P3, and therefore cannot visually recognize the whole display image.

Above things considered, according to the embodiment, the optical element 11 for generating an intermediate image has the lens-array inside area 12X where the microlenses 13X with the curvature radius Rin are arranged and the lens-array outside area 12Y where the microlenses 13Y with the curvature radius Rout smaller than the curvature radius Rin are arranged. Thereby, when letting the observer visually recognize the display image through the combiner 16, the light source unit 1 can let the observer clearly see the inside part of the display image by raising the luminance thereof while letting the observer visually recognize the whole display image without a loss of the outer part thereof.

[Modifications]

Hereinafter, a description will be given of preferred modifications of the embodiment according to the present invention. Each modification mentioned later can be applied to the above-mentioned embodiment in combination.

(First Modification)

The lens-array outside area 12Y in FIG. 3 is formed to surround the outer edge of the lens-array inside area 12X. However, the configuration to which the present invention can be applied is not limited to the configuration. Instead of this, the lens-array outside area 12Y may be a part of the area illustrated in FIG. 3.

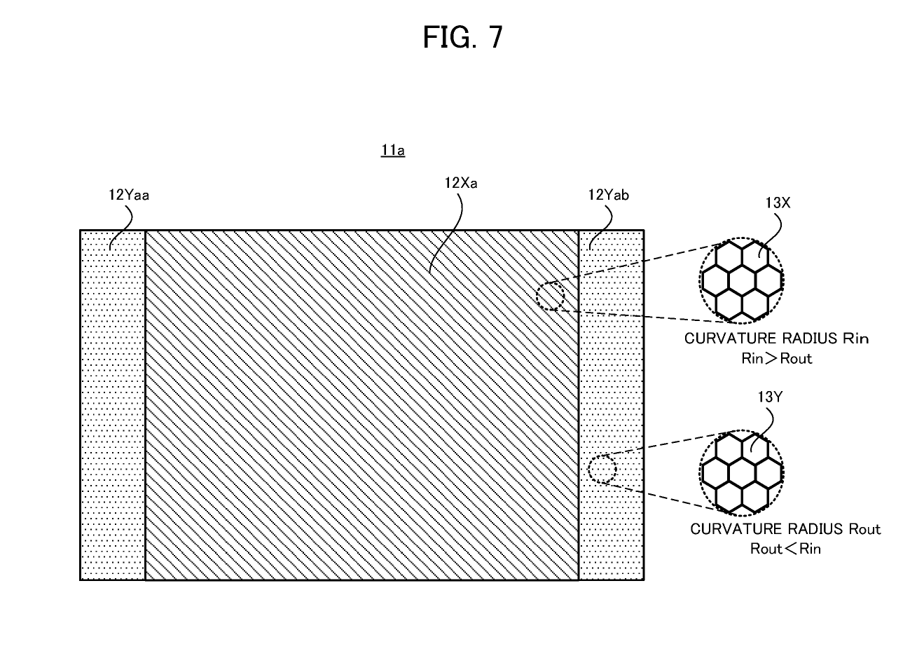

FIG. 7 illustrates a plane view of the optical element 11a for generating an intermediate image according to the modification. As illustrated in FIG. 7, the optical element 11a for generating an intermediate image includes a lens-array inside area 12Xa in the inside part of the optical element 11a for generating an intermediate image in the longitudinal direction, and lens-array outside areas 12Yaa and 12Yab in the both ends thereof in the longitudinal direction. The microlenses 13X with the curvature radius Rin are arranged on the lens-array inside area 12Xa, and the microlenses 13Y with the curvature radius Rout are arranged on the lens-array outside area 12Yaa and 12Yab.

According to the optical element 11a for generating an intermediate image, only on the both ends in the longitudinal direction whose passing light might not reach the eye point Pe, there are provided the lens-array outside areas 12Yaa and 12Yab where the microlenses 13Y with a relatively small curvature radius are arranged. Even in this case, the light source unit 1 can raise the luminance of the inside part of the display image indicating relatively important information thereby to let the observer clearly see the inside part and to let the observer visually recognize the whole part of the display image.

In a case that the optical element 11a for generating an intermediate image is irradiated by a laser scanning light source, each of the lens-array outside areas 12Yaa and 12Yab corresponds to an area where the scan speed is relatively slow. Thus, in this case, the light source unit 1 can keep the brightness of the display image configured by the light which passes through the lens-array outside areas 12Yaa and 12Yab thereby to let the observer clearly see the whole display image.

(Second Modification)

The optical element 11 for generating an intermediate image in FIG. 3 is separated into two areas (i.e., the lens-array inside area 12X and the lens-array outside area 12Y) where the microlenses 13X or microlenses 13Y with the different curvature radii are arranged. However, the configuration of the optical element 11 for generating an intermediate image to which the present invention can be applied is not limited to the configuration.

Instead, the optical element 11 for generating an intermediate image may be separated into more than two areas whose arranged microlenses have different curvature radii per area. According to this configuration, the light source unit 1 lets the observer visually recognize the whole display image while raising the luminance of the display image in stages from the outer part to the inside part.

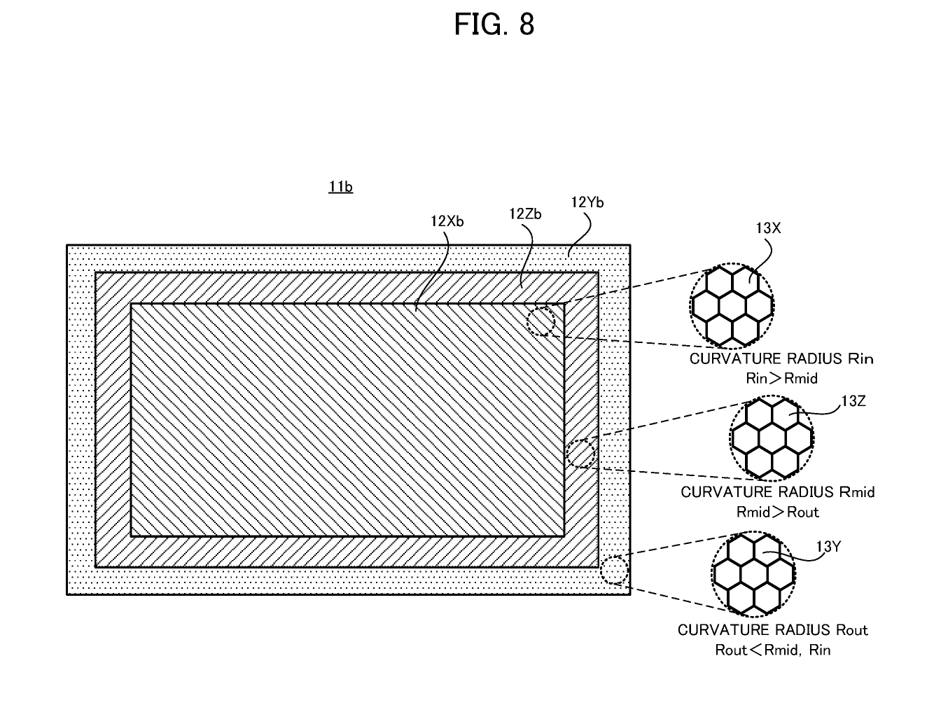

FIG. 8 illustrates a plane view of the optical element 11b for generating an intermediate image according to the second modification. As illustrated in FIG. 8, the optical element 11b for generating an intermediate image has a lens-array inside area 12Xb nearest to the center, a lens-array outside area 12Yb farthest from the center, and a lens-array intermediate area 12Zb that is an intermediate area existing between the lens-array inside area 12Xb and the lens-array outside area 12Yb.

In this case, the farther the area exists from the center, the smaller the curvature radius of microlenses arranged on the area becomes. Concretely, in case of FIG. 8, when the curvature radius of the microlenses 13Z arranged on the lens-array intermediate area 12Zb is defined as “Rmid”, the curvature radii of microlenses 13X, 13Y, 13Z meet relationships indicated by the following equation (3).

Rin>Rmid>Rout (3)

In this case, the diffusing angle of the light passing through the lens-array inside area 12Xb is the smallest diffusing angle, and the diffusing angle of the light passing through the lens-array outside area 12Yb is the largest diffusing angle. The luminance of the display image rises in stages from the outer part through the center part. Thus, even in the case of the second modification, the light source unit 1 can let the observer clearly see the inside part of the display image which shows relatively important information by keeping the luminance at the inside part while letting the observer visually recognize the whole display image.

(Third Modification)

The above-mentioned optical element 11 for generating an intermediate image is configured of one microlens array. However, the configuration to which the present invention can be applied is not limited to the configuration. Instead, the optical element 11 for generating an intermediate image may be configured of two microlens arrays.

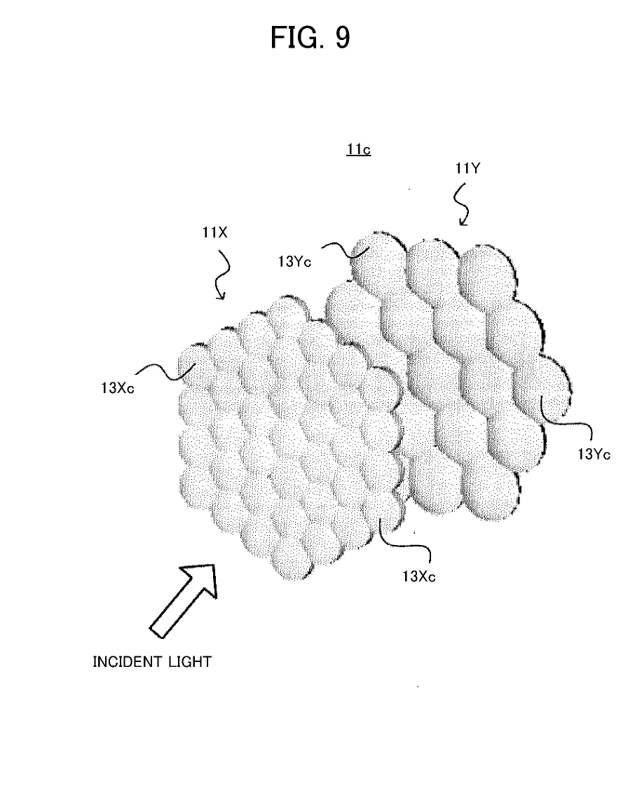

FIG. 9 is a perspective view of the optical element 11c for generating an intermediate image according to the third modification. As shown in FIG. 9, the optical element 11c for generating an intermediate image has a first microlens array 11X and a second microlens array 11Y arranged to face each other and to have an interval of a predetermined distance. Each of the first and the second microlens arrays 11X and 11X is formed into a substantially discoid shape. Additionally, microlenses 13Xc are arranged on one side of the first microlens array 11X in a lattice pattern, and microlenses 13Yc are arranged on one side of the second microlens array 11Y in a lattice pattern.

Besides, as illustrated in FIG. 9, the first microlens array 11X is arranged on the side of the incident light while the second microlens array 11Y is arranged on the side of the outgoing light. Namely, the light firstly enters the first microlens array 11X and thereafter the light outputted from the first microlens array 11X enters the second microlens array 11Y.

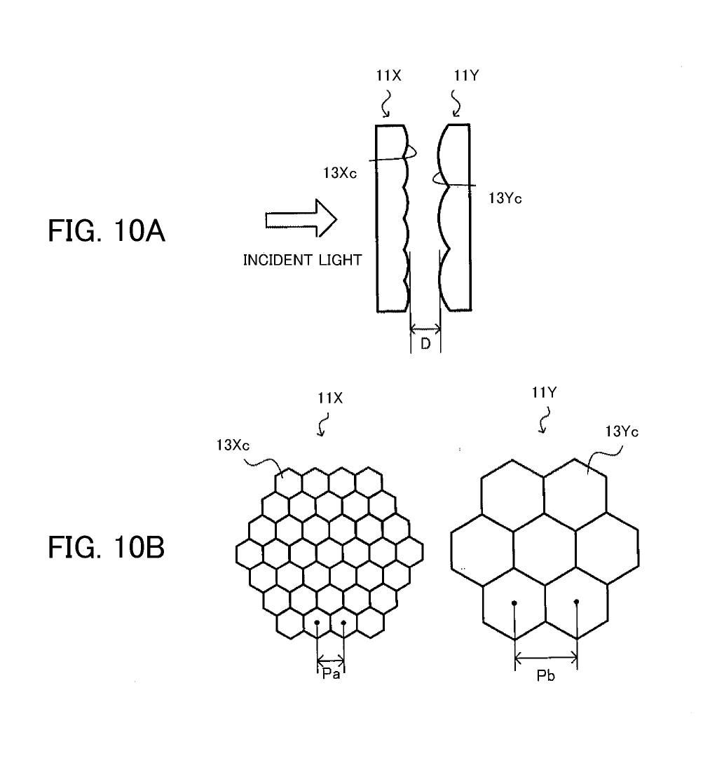

FIGS. 10A and 10B illustrate concrete configurations of the first microlens array 11X and the second microlens array 11Y. FIG. 10A is a cross-sectional view of the first microlens array 11X and the second microlens array 11Y which are cut by a plane parallel to the traveling direction of the light. Concretely, the cross-sectional view shows parts of the first microlens array 11X and the second microlens array 11Y in an enlarged manner. As illustrated in FIG. 10A, on the opposed sides of the first and the second microlens arrays 11X and 11Y, there are formed plural microlenses 13Xc and 13Yc. The first and the second microlens arrays 11X and 11Y are arranged to face each other at the position where the distance therebetween is a distance D. The distance D is at least longer than the focal length of the microlens 13Xc arranged on the first microlens array 11X.

FIG. 10B is plane views of the first microlens array 11X and the second microlens array 11Y. Concretely, the plane views show parts of the first microlens array 11X and the second microlens array 11Y, which are observed from the traveling direction of the light, in an enlarged manner.

As illustrated in FIG. 10B, the first microlens array 11X and the second microlens array 11Y are configured so that the lens pitch “Pa” of the microlens 13Xc arranged in the first microlens array 11X differs from the lens pitch “Pb” of the microlens 13Yc arranged in the second microlens array 11Y. Specifically, the first microlens array 11X and the second microlens array 11Y are configured so that the lens pitch Pa of the first microlens array 11X is smaller than the lens pitch Pb of the second microlens array 11Y. For example, the first microlens array 11X and the second microlens array 11Y are configured so that the lens pitch Pa of the microlens 13Xc is equal to or smaller than a half of the lens pitch Pb of the microlens 13Yc.

According to the configurations, the light focused by plural microlenses 13Xc in the first microlens array 11X enters one microlens 13Yc in the second microlens array 11Y. Accordingly, more than one pixels formed by plural microlenses 13Xc in the first microlens array 11X are focused by one microlens 13Yc in the second microlens array 11Y to constitute one pixel. Namely, at least two pixels formed by plural microlenses 13Xc in the first microlens array 11X are synthesized into a pixel larger than each of the pixels by one microlens 13Yc in the second microlens array 11Y. Thereby, it is possible to suppress a luminescent spot from standing out. Thus, according to the configurations of the modification, it is possible to properly suppress excessive generation of luminescent points even when the intermediate image generated by the second microlens array 11Y is displayed in an enlarged manner.

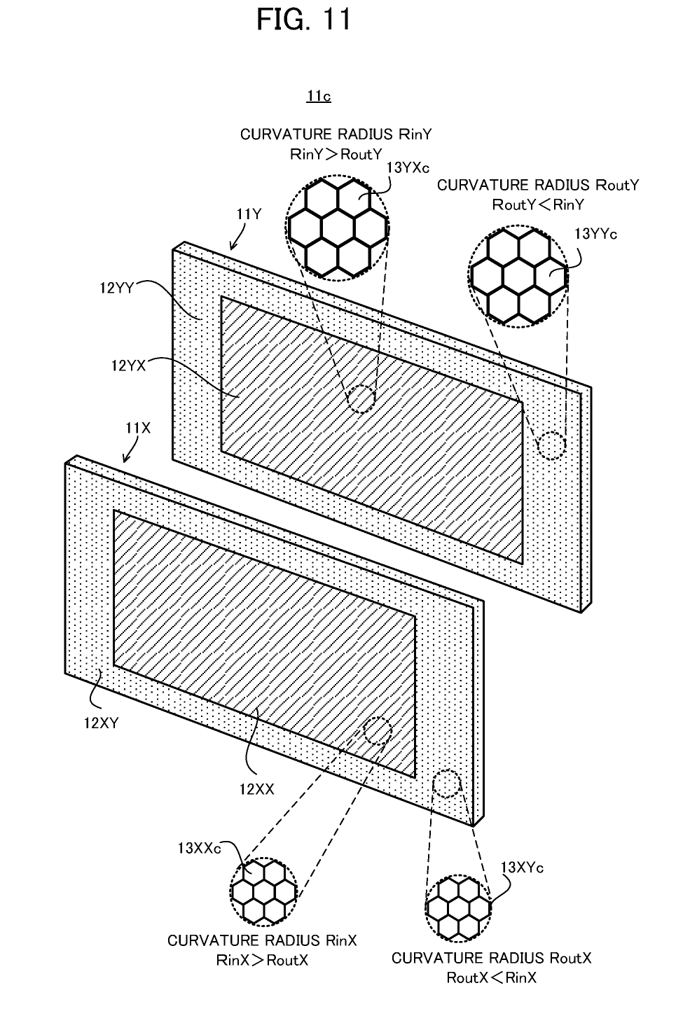

In the configurations, at least one of the first microlens array 11X and the second microlens array 11Y has an outside area and an inside area whose arranged microlenses have different curvature radii per area. The curvature radius of the microlens arranged in the outside area is designed to be smaller than the curvature radius of the microlens arranged in the inside area. The detail description will be given with reference to FIG. 11.

FIG. 11 is a perspective view of the optical element 11c for generating an intermediate image provided with the first microlens array 11X and the second microlens array 11Y each having an outside area and an inside area whose arranged microlenses have different curvature radii per area.

As illustrated in FIG. 11, the first microlens array 11X has a lens-array inside area 12XX where microlenses 13XXc with a curvature radius “RinX” are arranged, and a lens-array inside area 12XY where microlenses 13XYc with a curvature radius “RoutX” are arranged. The curvature radius RinX of the microlenses 13XXc arranged in the lens-array inside area 12XX is larger than the curvature radius RoutX of the microlenses 13XYc arranged in the lens-array inside area 12XY as indicated by the following equation (4).

RinX>RoutX (4)

Similarly, the second microlens array 11Y has a lens-array outside area 12YX where microlenses 13YXc with a curvature radius “RinY” are arranged and a lens-array outside area 12YY where microlenses 13YYc with a curvature radius “RoutY” are arranged. The curvature radius RinY of the microlenses 13YXc arranged in the lens-array outside area 12YX is larger than the curvature radius RoutY of the microlenses 13YYc arranged in the lens-array outside area 12YY as indicated by the following equation (5).

RinY>RoutY (5)

The above mentioned configuration of the optical element 11c for generating an intermediate image enables the light for displaying the center part of the image to enter the eye point Pe with a proper light intensity and also enables the light for displaying the outer part of the image to enter the eye point Pe. Thus, as with the embodiment, the light source unit 1 can let the observer clearly see the inside part of the display image which shows relatively important information in a state that a high luminance is kept while letting the observer visually recognize the whole display image.

(Fourth Modification)

The configuration of the head-up display 100 in FIG. 1 is one example, and the configuration to which the present invention can be applied is not limited to the configuration. For example, the head-up display 100 may not have the combiner 16. In this case, the light source unit 1 projects the light onto the front window 25 thereby to let the front window 25 reflect the display image to the eye point Pe of the driver. The installation position of the light source unit 1 is not limited to the ceiling board 27, and the light source unit 1 may be provided inside the dashboard 29 instead. In this case, on the dashboard 29, there is provided an aperture for letting the light pass towards the combiner 16 or the front window 25.

### INDUSTRIAL APPLICABILITY

This invention can be used for a display device using a laser light source such as a head-up display.

### DESCRIPTION OF REFERENCE NUMBERS

1 Light source unit
3 Video ASIC
7 Laser driver ASIC
8 MEMS control unit
9 Laser light source unit
11 Optical element for generating an intermediate image
16 Combiner
100 Head-up display

1. An optical element for generating an image perceived as a virtual image in a head-up display, comprising:
a microlens array on which plural microlenses are arranged,
wherein the microlens array includes plural areas whose microlenses arranged thereon have different curvature radii per area, and
wherein the farther the area exists from a center of the microlens array, the smaller the curvature radius of the microlenses arranged on the area is.

2. The optical element according to claim 1,
wherein the microlens array includes the plural areas that are an outside area corresponding to an outside part of the microlens array and an inside area surrounded by the outside area, and
wherein the curvature radius of the microlenses arranged on the outside area is smaller than the curvature radius of the microlenses arranged on the inside area.

3. The optical element according to claim 1,
wherein the microlens array includes the plural areas that are outside areas and an inside area, the outside areas being provided on both ends of the microlens array in a longitudinal direction of the microlens array, the inside area existing between the outside areas in the longitudinal direction, and
wherein the curvature radius of the microlenses arranged on the outside areas is smaller than the curvature radius of the microlenses arranged on the inside area.

4. The optical element according to claim 2,
wherein the microlens array further includes at least one intermediate area existing between the outside area(s) and the inside area, and
wherein the curvature radius of the microlenses arranged on the at least one intermediate area is smaller than the curvature radius of the microlenses arranged on the inside area and larger than the curvature radius of the microlenses arranged on the outside area(s).

5. The optical element according to claim 1, comprising:
a first and a second microlens arrays facing each other and each having plural microlenses arranged thereon, and
wherein at least one of the first and the second microlens arrays is configured as the microlens array.

6. A head-up display which includes the optical element according to any claim 1 and makes a user perceive an image formed by the optical element as a virtual image at an eye position of the user.

7. A light source unit comprising:
an optical element for generating an image perceived as a virtual image in a head-up display, the optical element being configured to include a microlens array on which plural microlenses are arranged, and
a light source configured to project light for displaying the image onto the optical element,
wherein the microlens array includes plural areas whose microlenses arranged thereon have different curvature radii per area, and
wherein the farther the area exists from a center of the microlens array, the smaller the curvature radius of the microlenses arranged on the area is.

8. The light source unit according to claim 7,
wherein the light source is a laser scanning light source.

9. The optical element according to claim 1,
wherein a center distance of any two adjacent microlenses selected from the plural microlenses is a constant distance.

10. The optical element according to claim 3,
wherein the microlens array further includes at least one intermediate area existing between the outside area(s) and the inside area, and
wherein the curvature radius of the microlenses arranged on the at least one intermediate area is smaller than the curvature radius of the microlenses arranged on the inside area and larger than the curvature radius of the microlenses arranged on the outside area(s).

11. The optical element according to claim 2, comprising:
a first and a second microlens arrays facing each other and each having plural microlenses arranged thereon, and
wherein at least one of the first and the second microlens arrays is configured as the microlens array.

12. The optical element according to claim 3, comprising:
a first and a second microlens arrays facing each other and each having plural microlenses arranged thereon, and
wherein at least one of the first and the second microlens arrays is configured as the microlens array.

13. The optical element according to claim 4, comprising:
a first and a second microlens arrays facing each other and each having plural microlenses arranged thereon, and
wherein at least one of the first and the second microlens arrays is configured as the microlens array.

14. A head-up display which includes the optical element according to claim 2 and makes a user perceive an image formed by the optical element as a virtual image at an eye position of the user.

15. A head-up display which includes the optical element according to claim 3 and makes a user perceive an image formed by the optical element as a virtual image at an eye position of the user.

16. A head-up display which includes the optical element according to claim 4 and makes a user perceive an image formed by the optical element as a virtual image at an eye position of the user.

17. A head-up display which includes the optical element according to claim 5 and makes a user perceive an image formed by the optical element as a virtual image at an eye position of the user.

18. A head-up display which includes the optical element according to claim 10 and makes a user perceive an image formed by the optical element as a virtual image at an eye position of the user.

19. A head-up display which includes the optical element according to claim 11 and makes a user perceive an image formed by the optical element as a virtual image at an eye position of the user.

20. A head-up display which includes the optical element according to claim 12 and makes a user perceive an image formed by the optical element as a virtual image at an eye position of the user.
